(19) United States
(12) Patent Application Publication
(10) Pub. No.: US 2026/0284873 A1
(43) Pub. Date: Sep. 24, 2026

(54) DEVICE AND METHOD FOR LIMITING OPERATION OF ROBOT, DEVICE AND METHOD FOR SETTING OPERATION PARAMETER, AND COMPUTER PROGRAM

(71) Applicant: Fanuc Corporation, Minamitsuru-gun, Yamanashi (JP)

(72) Inventor: Motoyuki TANAKA, Minamitsuru-gun, Yamanashi (JP)

(73) Assignee: Fanuc Corporation, Minamitsuru-gun, Yamanashi (JP)

(21) Appl. No.: 19/473,876

(22) PCT Filed: Apr. 17, 2023
(86) PCT No.: PCT/JP2023/015366

§ 371 Date: Oct. 9, 2025

(51) Int. Cl. B25J 9/16; B25J 13/08

(52) U.S. Cl. CPC B25J 9/1628; B25J 9/1676; B25J 13/085; G05B 2219/37425; G05B 2219/39001

(57) ABSTRACT

When all operations of a robot outside an allowable operation range are prohibited, work efficiency may decrease. Meanwhile, when overload is applied to the robot while operating outside the allowable operation range, damage may occur to the robot. This device for limiting the operation of a robot comprises: an information acquisition unit that acquires information relating to a load applied to a robot; a range determination unit that determines, on the basis of the information acquired by the information acquisition unit, whether or not the robot is outside the allowable operation range determined in accordance with the load; and an operation limiting unit that, when the range determination unit has determined that the robot is outside the allowable operation range, permits an operation of the robot toward the allowable operation range while prohibiting an operation of the robot departing from the allowable operation range.

### CROSS-REFERENCE TO RELATED APPLICATIONS

This application is the United States National Phase under 35 U.S.C. § 371 of PCT International Patent Application No. PCT/JP2023/015366, filed on Apr. 17, 2023, the disclosure of which is hereby incorporated by reference herein in its entirety for all purposes.

### TECHNICAL FIELD

This disclosure relates to a device and method for limiting an operation of a robot, a device and method for setting operation parameters, and a computer program.

### BACKGROUND ART

A device for determining an allowable operation range of a robot is known (for example, Patent Literature 1).

### CITATION LIST

### Patent Literature

PTL 1: WO 2021/187378

### SUMMARY OF INVENTION

### Technical Problem

When all motions of a robot outside of an allowable operation range are prohibited, work efficiency may decrease. On the other hand, when an overload is applied to a robot operating outside of the allowable operation range, damage may occur to the robot.

### Solution to Problem

In an aspect of the present disclosure, a device for limiting an operation of a robot includes an information acquisition unit configured to acquire information on a load applied to the robot; a range determination unit configured to determine whether or not the robot is outside of an allowable operation range determined in response to the load, based on the information acquired by the information acquisition unit; and an operation limiting unit configured to permit the operation of the robot moving toward inside of the allowable operation range and prohibit the operation of the robot moving away from the allowable operation range when the range determination unit determines that the robot is outside of the allowable operation range.

A device for setting an operation parameter of a robot configured to perform a predetermined operation includes an information acquisition unit configured to acquire information on a load applied to the robot; a parameter setting unit configured to set the operation parameter to cause the robot to execute the predetermined operation, based on the information acquired by the information acquisition unit; and a range determination unit configured to determine whether or not the robot is outside of an allowable operation range determined in response to the load indicated by the information acquired by the information acquisition unit. The parameter setting unit suspends a setting of the operation parameter when the range determination unit determines that the robot is outside of the allowable operation range.

A method of limiting an operation of a robot includes acquiring, by a processor, information on a load applied to the robot; determining, by the processor, whether or not the robot is outside of an allowable operation range determined in response to the load, based on the acquired information; and permitting, by the processor, the operation of the robot moving toward inside of the allowable operation range when the robot is determined to be outside of the allowable operation range, and prohibiting the operation of the robot moving away from the allowable operation range when the robot is determined to be outside of the allowable operation range.

A method of setting an operation parameter of a robot configured to perform a predetermined operation includes acquiring, by a processor, information on a load applied to the robot; setting, by the processor, the operation parameter to cause the robot to execute the predetermined operation, based on the acquired information; determining, by the processor, whether or not the robot gripping a workpiece is outside of an allowable operation range determined in response to the load indicated by the acquired information; and suspending, by the processor, a setting of the operation parameter when the robot is determined to be outside of the allowable operation range.

### BRIEF DESCRIPTION OF DRAWINGS

FIG. 1 is a schematic diagram of a robot system according to an embodiment.

FIG. 2 is a block diagram of the robot system illustrated in FIG. 1.

FIG. 3 is a flowchart showing functions of the robot system illustrated in FIG. 2.

FIG. 4 illustrates an example of an allowable operation range.

FIG. 5 illustrates an example of a database of the allowable operation range.

FIG. 6 is a flowchart showing an example of a flow of step S4 in FIG. 3.

FIG. 7 is a flowchart showing an example of a flow of step S5 in FIG. 7.

FIG. 8 is a block diagram illustrating other functions of the robot system illustrated in FIG. 1.

FIG. 9 is a flowchart showing functions of the robot system illustrated in FIG. 8.

FIG. 10 is a flowchart showing an example of a flow of step S36 in FIG. 9.

FIG. 11 is a flowchart showing other functions of the robot system illustrated in FIG. 8.

FIG. 12 is a flowchart showing an example of a flow of step S37 in FIG. 11.

FIG. 13 is a block diagram illustrating other functions of the robot system illustrated in FIG. 2.

FIG. 14 is a flowchart showing functions of the robot system illustrated in FIG. 13.

FIG. 15 illustrates an example of image data indicating an allowable operation range AR.

FIG. 16 illustrates an example of an allowable orientation range.

FIG. 17 illustrates an example of the allowable orientation range.

FIG. 18 illustrates an example of the allowable orientation range.

### DESCRIPTION OF EMBODIMENTS

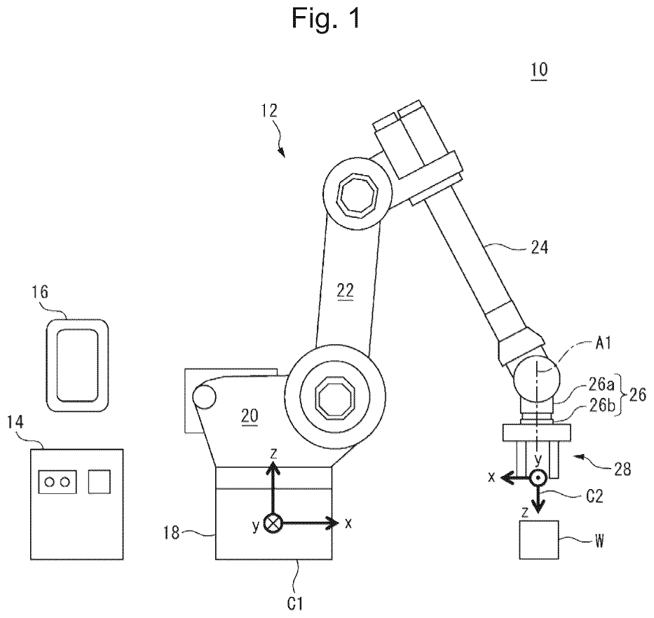

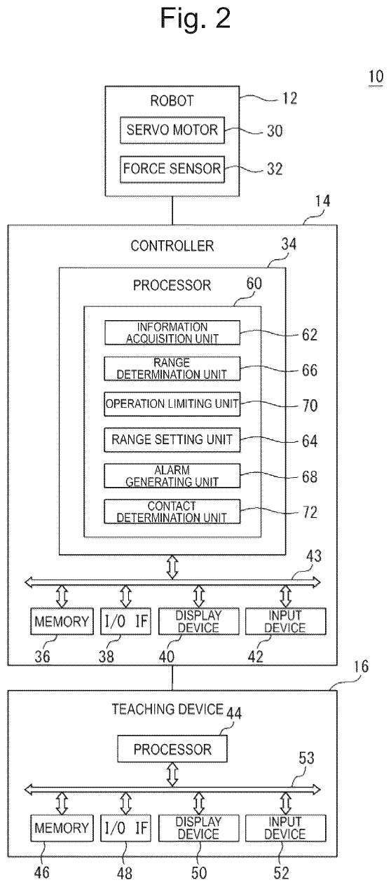

Hereinafter, embodiments of the present disclosure will be described in detail with reference to the drawings. In various embodiments to be described below, the same elements are denoted by the same reference numerals, and duplicated description thereof will be omitted. First, a robot system 10 according to an embodiment will be described with reference to FIGS. 1 and 2. The robot system 10 includes a robot 12, a controller 14, and a teaching device 16.

The robot 12 is a vertical articulated robot, and performs a predetermined operation. In the present embodiment, the robot 12 performs a conveying operation CO of conveying a workpiece W placed at a predetermined initial position Pi to a predetermined conveying position Pc, as the predetermined operation. Specifically, the robot 12 includes a robot base 18, a rotating body 20, a lower arm part 22, an upper arm part 24, a wrist part 26, and a robot hand 28. The robot base 18 is fixed to a floor of a work cell or on an automated guided vehicle (AGV).

The rotating body 20 is mounted on the robot base 18 to be rotatable around a vertical axis. The lower arm part 22 has a base end part mounted on the rotating body 20 to be rotatable around a horizontal axis. The upper arm part 24 has a base end part rotatably provided at a distal end part of the lower arm part 22. The wrist part 26 includes a wrist base 26a provided at a distal end part of the upper arm part 24 to be rotatable about two axes orthogonal to each other, and a wrist flange 26b provided at the wrist base 26a to be rotatable about a wrist axis A1.

The robot hand 28 is detachably attached to a wrist flange 24b. As an example, the robot hand 28 includes a plurality of claws that can be opened and closed, and grips the workpiece W by clamping the workpiece W between the claws. As another example, the robot hand 28 includes an adsorption part (vacuum, suction cup, or the like) that generates negative pressure between the robot hand 28 and the workpiece W, and the adsorption part adsorbs and grips the workpiece W.

The respective components (the robot base 18, rotating body 20, lower arm part 22, upper arm part 24, wrist part 26) of the robot 12 are provided with a servo motor 30 (FIG. 2). These servo motors 30 rotate and drive the respective drive shafts of the robot 12 in accordance with commands from the controller 14, thereby rotating respective movable components of the robot 12 such as the rotating body 20, the lower arm part 22, the upper arm part 24, the wrist base 26a, and the wrist flange 26b (that is, the robot hand 28) around the respective drive shafts. This allows the robot 12 to move the workpiece W gripped by the robot hand 28 to any position.

Further, the robot 12 is provided with a force sensor 32 (FIG. 2) that detects an external force F applied to the robot 12. The force sensor 32 includes, for example, a 6-axis force sensor provided in any component (for example, the robot base 18 or wrist part 26) of the robot 12, or a torque sensor provided in each the servo motor 30, and supplies detection data Df of the detected force F to the controller 14.

A robot coordinate system C1 and a tool coordinate system C2 are set for the robot 12. The robot coordinate system C1 is a fixed coordinate system for controlling the operation of each movable component of the robot 12. In the present embodiment, the robot coordinate system C1 is set relative to the robot base 18 such that the origin is located at the center of the robot base 18 and the z-axis is parallel to (specifically, coincides with) the pivot axis of the rotating body 20.

On the other hand, the tool coordinate system C2 is a moving coordinate system that defines the position P and orientation O of the robot hand 28 in the robot coordinate system C1. In the present embodiment, the tool coordinate system C2 is set with respect to the robot hand 28 such that an origin (so-called TCP) thereof is disposed at a workpiece gripping position of the robot hand 28 and a z axis thereof is parallel to (specifically, coincides with) the wrist axis A1. An origin of the tool coordinate system C2 may be disposed at a center of the wrist flange 26b.

When the controller 14 moves the robot hand 28 in the robot coordinate system C1, the controller 14 sets the tool coordinate system C2 in the robot coordinate system C1 and generates a command to each servo motor 30 to dispose the robot hand 28 at the position P and orientation O indicated by the set tool coordinate system C2. Thus, the controller 14 can drive each servo motor 30 to position the robot hand 28 (and the gripped workpiece W) at any position P and orientation O in the robot coordinate system C1.

The controller 14 is a computer including a processor 34, a memory 36, an I/O interface 38, a display device 40, and an input device 42. The processor 34 includes a CPU, a GPU, and the like, is communicatively connected to the memory 36, the I/O interface 38, the display device 40, and the input device 42 via a bus 43, and performs calculation processing for realizing various functions to be described below while communicating with these components.

The memory 36 includes a RAM, a ROM, or the like, and temporarily or permanently stores various types of data. The memory 36 may be a computer-readable non-transitory recording medium such as a semiconductor memory, a magnetic recording medium, or an optical recording medium. The I/O interface 38 has, for example, an Ethernet (trade name) port, a USB port, an optical fiber connector, or an HDMI (trade name) terminal, and communicates data with an external device via a wired or wireless connection under commands from the processor 34.

The display device 40 includes a liquid crystal display, an organic EL display, or the like, and displays various types of data in a visible manner under commands from the processor 34. The input device 42 includes a push button, a switch, a keyboard, a mouse, or a touch panel, or the like, and receives data input from an operator. The display device 40 and the input device 42 may be integrated into a housing of the controller 14, or may be connected to the I/O interface 38 as a computer (PC or the like) separate from the housing of the controller 14.

The teaching device 16 teaches an operation of the robot 12. Specifically, the teaching device 16 is a computer having a processor 44, a memory 46, an I/O interface 48, a display device 50, and an input device 52. The teaching device 16 may be any type of computer, such as a teaching pendant, a laptop computer or tablet PC.

The processor 44 is communicatively connected to the memory 46, the I/O interface 48, the display device 50, and the input device 52 via the bus 53. The configuration of the processor 44, the memory 46, the I/O interface 48, the display device 50, and the input device 52 is the same as that of the processor 34, the memory 36, the I/O interface 38, the display device 40, and the input device 42 described above, so that duplicate descriptions are omitted.

In the present embodiment, the processor 34 of the controller 14 is configured to be able to execute a jog mode MD1 and a lead-through teach mode MD2 as an operation mode MD of the robot 12. In the jog mode MD1, the processor 34 operates the movable components of the robot 12 in accordance with a jog command CMj input by the operator handling the input device 52 of the teaching device 16.

On the other hand, in the lead-through teach mode MD2, the processor 34 receives a handling force Fh applied to an arbitrary movable component (for example, the wrist part 26 or the robot hand 28) of the robot 12 by the operator as a lead-through teaching command CMd, and moves the movable component to which the handling force Fh is applied, in a direction of the handling force Fh.

The processor 34 can calculate a magnitude and direction of the handling force Fh of the operator and identify the movable component to which the handling force Fh is applied, based on the detection data Df of the force sensor 32. In this manner, in the present embodiment, the processor 34 operates the robot 12 in accordance with the jog command CMj or lead-through teaching command CMd (the handling force Fh) from the operator.

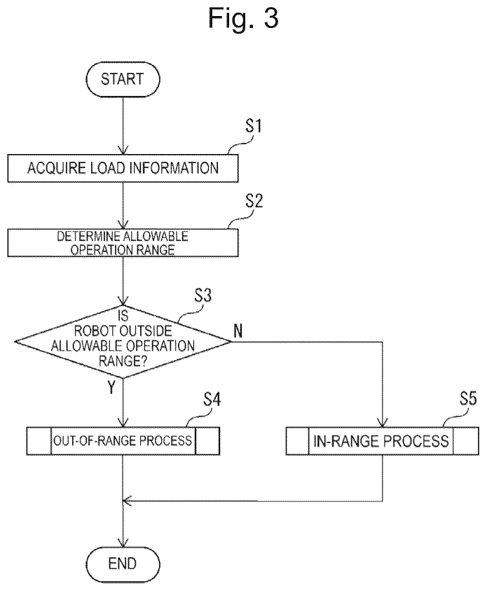

Next, functions of the robot system 10 will be described with reference to FIG. 3. Hereinafter, the functions of the robot system 10 when the operator teaches the above-described conveying operation CO to the robot 12 will be described. The operator gives the above-described jog command CMj or lead-through teaching command CMd to the processor 34, and causes the robot hand 28 to grip the workpiece W placed at the initial position Pi. The processor 34 starts a flow of FIG. 3 when the robot hand 28 grips the workpiece W.

In step S1, the processor 34 acquires the information IF1 on the load L applied to the robot 12 from the workpiece W. The load L applied to the robot 12 includes, for example, a weight WG and an inertia IN of the workpiece W, a moment MO applied from the workpiece W to the wrist part 26 (to be specific, the wrist flange 26b), and a load torque TQ applied to each servo motor 30. Information IF1 on the load L includes, for example, a value of the load L (that is, the weight WG, the inertia IN, the moment MO, the load torque TQ, or the like) and a coordinate Qg of a center of gravity position of the load L. The coordinate Qg of the center of gravity position may be expressed as a coordinate of the tool coordinate system C2 set in the robot hand 28 gripping the workpiece W.

As an example, the information IF1 on the load L (that is, the value of the load L, the coordinate Qg of the center of gravity position, or the like) is stored in the memory 36 (or 46) in advance in association with the type (an identification number, a model number, or the like) of the workpiece W conveyed by the robot 12. The processor 34 may recognize a type of workpiece W gripped by the robot 12 at the start in FIG. 3, and may acquire the information IF1 corresponding to the workpiece W by reading the information IF1 from the memory 36.

In this case, the operator may handle the input device 42 (or 52) to input information on the type of workpiece W. Alternatively, the processor 34 may acquire the information on the type of workpiece W from the teaching program. As another example, the operator may handle the input device 42 (or 52) to manually input the information IF1 on the load L, and the processor 34 may acquire the information IF1 through the input device 42.

As yet another example, the processor 34 may actually measure the value (the weight WG, inertia IN, moment MO, or load torque TQ) of the load L as the information IF1 based on the detection data Df of the force sensor 32. Thus, the processor 34 acquires the information IF1 on the load L by reading the information IF1 from the memory 36, receiving the information IF1 from the operator, or by performing actual measurement. Therefore, the processor 34 functions as an information acquisition unit 62 (FIG. 2) that acquires the information IF1 on the load L.

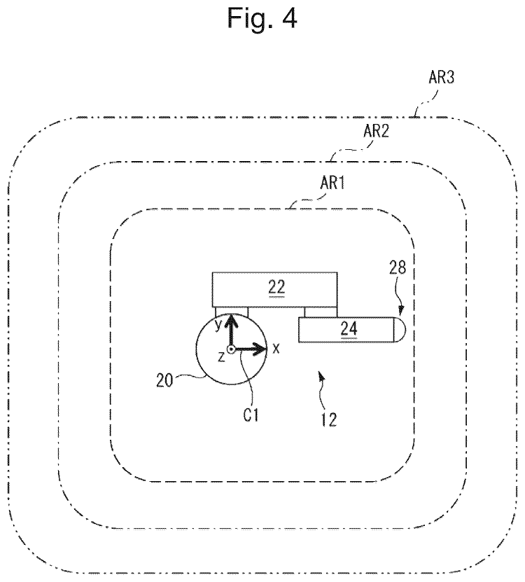

In step S2, the processor 34 determines the allowable operation range AR in response to the load L indicated in the information IF1 acquired in step S1. Here, from the viewpoint of avoiding an overload on the robot 12, the allowable operation range AR is determined for the robot 12 in response to the load L. An example of the allowable operation range AR is illustrated in FIG. 4.

In the present embodiment, the allowable operation range AR is an allowable position range that defines an allowable range of the position P of the robot 12 (to be specific, the robot hand 28 or the tool coordinate system C2). In the example illustrated in FIG. 4, as the allowable operation range AR, an allowable operation range AR1, an allowable operation range AR2 wider than the allowable operation range AR1, and an allowable operation range AR3 wider than the allowable operation range AR2 are determined. The widest allowable operation range AR3 may be defined by a maximum reach distance that the robot 12 can reach with the robot hand 28.

For example, the allowable operation range AR1 is applied to a range in which a distance d from the robot base 18 (that is, an origin of the robot coordinate system C1) is d≤d1 (for example, d1=100 [mm]) and the load L is L≥L1 (for example, load L=weight WG>L1=20 kg). On the other hand, the allowable operation range AR2 is applied to a range in which the distances d is d≤d2 (for example, d2=300 [mm]) and the load L is L2≤L<L1 (for example, L2=10 [kg] ≤L=WG≤L1=20 [kg]).

Also, the allowable operation range AR3 is applied to a range in which the distance d is d≤d3 (for example, d3=500 [mm]) and the load L is 0≤L<L2. Although FIG. 4 illustrates a case in which three allowable operation ranges AR1, AR2, and AR3 are determined, two allowable operation ranges AR may be determined, or four or more allowable operation ranges AR may be determined.

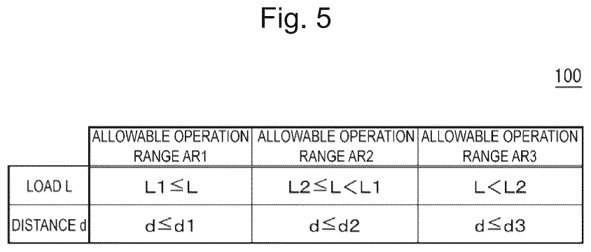

As an example, a database 100 in which a plurality of allowable operation ranges AR1, AR2, and AR3, each having a different range, are stored in association with the load L as illustrated in FIG. 4 is created in advance. An example of the database 100 is illustrated in FIG. 5. The database 100 is created by the operator and stored in the memory 36 (or 46) in advance.

In this step S2, the processor 34 selects the allowable operation range AR corresponding to the load L indicated in the information IF1 acquired in step S1 from the plurality of allowable operation ranges AR1, AR2, and AR3 stored in the database 100. For example, it is assumed that, in the information IF1 acquired in step S1, the load L=weight WG=15 [kg], L2=10 [kg], and L1=20 [kg]. In this case, the processor 34 applies the load L=15 [kg] to the database 100 and selects the allowable operation range AR2 in which the load L is L2=10 [kg]≤L<L1=20 [kg]. Thus, the processor 34 selects the allowable operation range AR1, AR2, or AR3 corresponding to the load L.

As another example, the processor 34 performs a predetermined calculation using the load L indicated in the information IF1 acquired in step SI to calculate the allowable operation range AR in response to the load L. For example, the distance d that defines the allowable operation range AR can be expressed as a function of the load L, which is d=f(L). Each term of this function f(L) can be determined by the operator. For example, it is assumed that the load L=weight WG=15 [kg] in the information IF1 acquired in step S1.

In this case, the processor 34 substitutes the load L=weight WG=15 [kg] into the function f(L). When d=f(15 [kg])=300 [mm], the processor 34 obtains the allowable operation range AR2 of d≥300 [mm]. Thus, the processor 34 performs a predetermined calculation (calculation of an equation d=f(L)) using the load L to obtain the allowable operation range AR in response to the load L.

As described above, in the present embodiment, when the processor 34 acquires the information IF1 in step S1, the processor 34 determines the allowable operation range AR (for example, the allowable operation range AR1, AR2, or AR3) by selecting the allowable operation range AR from the database 100 or performing a predetermined calculation in response to the load L indicated by the information IF1. Therefore, the processor 34 functions as a range setting unit 64 (FIG. 2) that determines the allowable operation range AR in response to the load L. The allowable operation range AR determined in step S2 is set as an operation parameter OP for causing the robot 12 to execute the conveying operation CO.

In step S3, the processor 34 determines whether or not the robot 12 gripping the workpiece W is outside of the allowable operation range AR based on the information IF1 acquired in step S1. For example, the processor 34 acquires a coordinate Q1 in the robot coordinate system C1 of an origin of the tool coordinate system C2 at this time point as the current position Pₙ of the robot 12.

Alternatively, the processor 34 may acquire a coordinate Q2 in the robot coordinate system C1 of the center of gravity position of the load L at this time point as the current position Pₙ of the robot 12. The coordinate Q2 of the center of gravity position in the robot coordinate system C1 can be obtained from the coordinate Q1 of the tool coordinate system C2 in the robot coordinate system C1 and the coordinate Qg of the center of gravity position in the tool coordinate system C2 included in the information IF1 acquired in step S1.

The processor 34 determines whether or not the acquired current position Pₙ is outside of the allowable operation range AR (for example, the allowable operation range AR1, AR2, or AR3) set based on the information IF1 (that is, the load L) in step S2. When the current position Pₙ is outside of the allowable operation range AR, the processor 34 determines YES and proceeds to step S4, whereas when the current position Pₙ is inside of the allowable operation range AR, the processor 34 determines NO and proceeds to step S5. Thus, in the present embodiment, the processor 34 functions as a range determination unit 66 (FIG. 2) that determines whether or not the robot 12 is outside of the allowable operation range AR based on the information IF1.

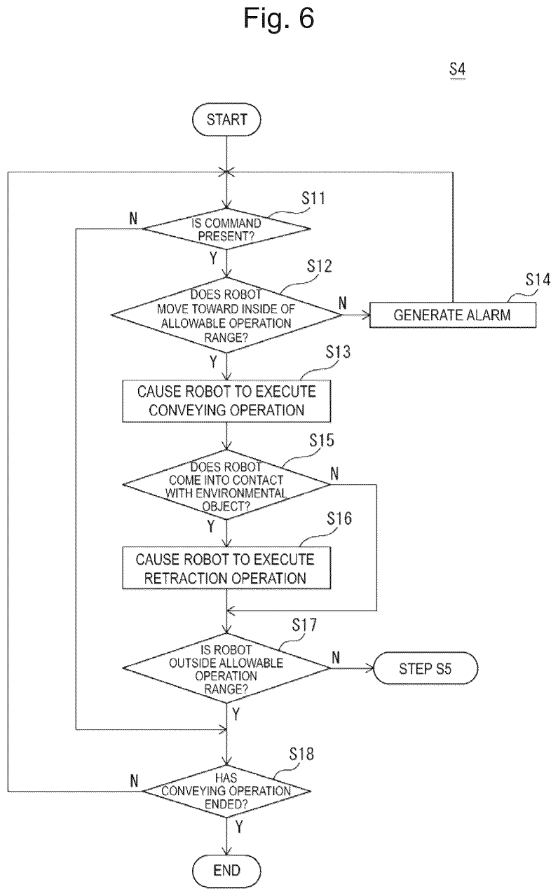

In step S4, the processor 34 executes an out-of-range process. This step S4 will be described with reference to FIG. 6. In step S11, the processor 34 determines whether a command CM for causing the robot 12 to execute the conveying operation CO has been received. For example, the operator issues the above-described jog command CMj or lead-through teaching command CMd to the processor 34 as the command CM to cause the robot 12 to execute the conveying operation CO. When the processor 34 receives the command CM (CMt or CMd), the processor 34 determines YES and proceeds to step S12, whereas the processor 34 proceeds to step S18 when the processor 34 determines NO.

In step S12, the processor 34 determines whether or not the robot 12 will move inside of the allowable operation range AR set in step S2 when the robot 12 is caused to execute the conveying operation CO in accordance with the command CM received in the most recent step S11. As an example, the processor 34 obtains a target position Pₙ₊₁ to which the robot hand 28 (that is, the workpiece W) is moved in accordance with the command CM.

For example, the processor 34 acquires, as the target position Pₙ₊₁, a coordinate Q3 of the origin of the tool coordinate system C2 set in the robot coordinate system C1 in accordance with the command CM. Alternatively, the processor 34 acquires, as the target position Pₙ₊₁, a coordinate Q4 in the robot coordinate system C1 of a center of gravity position of the workpiece W that the robot 12 moves in accordance with the command CM. The coordinate Q4 of the center of gravity position can be obtained from the coordinate Q3 of the origin of the tool coordinate system C2 and the coordinate Qg of the center of gravity position included in the information IF1 obtained in step S1.

The processor 34 obtains a distance δₙ₊₁ from the obtained target position Pₙ₊₁ to the boundary B of the allowable operation range AR set in step S2, and a distance δₙ from the current position Pₙ of the robot 12 at this time to the boundary B. The processor 34 then determines that the robot 12 moves toward the inside of the allowable operation range AR (that is, YES) when δₙ₊₁<δₙ is satisfied.

As another example, the processor 34 obtains a moving direction (or a movement vector) DR in which the robot hand 28 (that is, the workpiece W) is moved in accordance with the command CM. For example, the processor 34 acquires a direction from the current position Pₙ to the target position Pₙ₊₁ described above as a moving direction DR. When the moving direction (movement vector) DR intersects the boundary B of the allowable operation range AR set in step S2, the processor 34 determines that the robot 12 moves toward the inside of the allowable operation range AR (that is, YES).

When the processor 34 determines YES, the processor 34 proceeds to step S13, but when the processor determines NO, the processor 34 proceeds to step S14. When a result of the determination is NO in step S12, this means that the robot hand 28 (that is, the workpiece W) moves in a direction in which the robot moves away from the allowable operation range AR when the robot 12 is operated in accordance with the command CM received in step S11.

In step S13, the processor 34 causes the robot 12 to execute the conveying operation CO. Specifically, the processor 34 operates the robot 12 in accordance with the command CM (CMt or CMd) received in the most recent step S11, and moves the workpiece W gripped by the robot hand 28. At this time, the robot 12 moves the workpiece W in a direction in which the robot 12 moves toward the inside of the allowable operation range AR set in step S2.

On the other hand, when the result of the determination in step S12 is NO, the processor 34 generates an alarm AL1 in step S14. For example, the processor 34 generates an image or sound alarm AL1 stating “The robot is overloaded. Any operation other than the operation of the robot moving toward the inside of the allowable operation range cannot be executed”. Then, the processor 34 displays the generated alarm AL1 on the display device 40 (or 50) or outputs the alarm AL1 through a speaker (not illustrated). The processor 34 returns to step S11. Thus, in the present embodiment, the processor 34 functions as an alarm generating unit 68 (FIG. 2) configured to generate the alarm AL1.

As described above, when the processor 34 determines YES in step S12, the processor 34 permits the execution of the conveying operation CO in step S13. On the other hand, even when the processor 34 continuously receives the command C in step S11, the processor 34 prohibits the execution of the conveying operation CO in step S13 by repeating a loop of the steps S11, S12, and S14 while the processor 34 determines NO in step S12. Therefore, the processor 34 functions as an operation limiting unit 70 (FIG. 2) that permits the conveying operation CO of the robot 12 moving toward the inside of the allowable operation range AR, while prohibiting the conveying operation CO of the robot 12 moving away from the allowable operation range AR.

In step S15, the processor 34 determines whether or not the robot 12 has come into contact with a surrounding environmental object E (the operator, a structure such as a pillar, another workpiece, or the like) based on the detection data Df of the force sensor 32. Specifically, the processor 34 calculates a magnitude and direction of the contact force Fc applied from the environmental object E to the robot 12 based on the detection data Df.

When a magnitude of the calculated contact force Fc exceeds a predetermined threshold value Fₜₕ (F>Fₜₕ), the processor 34 determines YES. When the processor 34 determines YES, the process proceeds to step S16, whereas when the processor 34 determines NO, the process proceeds to step S17. Thus, in the present embodiment, the processor 34 functions as a contact determination unit 72 (FIG. 2) that determines whether or not the robot 12 has come into contact with the environmental object E based on the detection data Df.

In step S16, the processor 34 causes the robot 12 to execute a retraction operation RO. Specifically, the processor 34 stops the conveying operation CO of the robot 12 that is executed in step S13. For example, a brake mechanism (not shown) that brakes the rotation of each servo motor 30 may be provided, and the processor 34 may operate the brake mechanism to brake the servo motor 30, thereby allowing the conveying operation CO of the robot 12 to be stopped in an emergency.

Then, the processor 34 causes the robot 12 to execute the retraction operation RO of moving the robot hand 28 in a direction DR′ opposite to the moving direction DR in the conveying operation CO in step S13. The processor 34 can acquire, as the direction DR′, a vector from the target position Pₙ₊₁ of the conveying operation CO of step S13 to the current position Pₙ at which the robot 12 is disposed before the target position Pₙ₊₁.

Here, in the above-described steps S12 and S13, the processor 34 functions as the operation limiting unit 70 to prohibit the conveying operation CO of the robot 12 moving away from the allowable operation range AR. However, in step S16, the processor 34 functions as the operation limiting unit 70, to permit the retraction operation RO in order to reliably eliminate contact between the robot 12 and the environmental object E even when the direction DR′ of the retraction operation RO is a direction in which the robot moves toward the outside of the allowable operation range AR (that is, the direction in which the robot moves away from the allowable operation range AR). As a result, the robot 12 executes the retraction operation RO of moving the robot hand 28 in the direction DR′.

In the retraction operation RO, the processor 34 may move the robot 12 (robot hand 28) in a direction opposite to the direction of the contact force Fc obtained in the most recent step S15. Further, in the retraction operation RO, the processor 34 may move the robot 12 (robot hand 28) by a predetermined distance, or may monitor a magnitude of the contact force Fc during the execution of the retraction operation RO and continue the retraction operation RO until the magnitude becomes equal to or smaller than the threshold value Fₜₕ (F≤Fₜₕ). Further, in the retraction operation RO, the processor 34 may move the robot 12 at a velocity V2 (<V1) lower than the velocity V1 of the robot 12 in the conveying operation CO of step S13.

Further, when the processor 34 is executing the above-described lead-through teach mode MD2, the processor 34 may move the robot 12 in the direction of the handling force Fh applied to the robot 12 by the operator until a predetermined time (for example, 10 seconds) elapses in the retraction operation RO. In this case, even when the direction of the handling force Fh is a direction in which the robot moves toward the outside of the allowable operation range AR, the processor 34 permits the movement of the robot 12 toward the outside of the allowable operation range AR (that is, in the direction of the handling force Fh).

In step S17, the processor 34 functions as the range determination unit 66 and determines whether or not the robot 12 is outside of the allowable operation range AR, similar to step S3 described above. When the processor 34 determines YES, the process proceeds to step S18. On the other hand, when the processor 34 determines NO (that is, the robot 12 is inside of the allowable operation range AR), the process proceeds to step S5 in FIG. 3.

In step S18, the processor 34 determines whether or not the conveying operation CO has ended. For example, the processor 34 determines YES when the workpiece W is conveyed to the conveying position Pc by the robot 12. Alternatively, the processor 34 may determine YES when an operation end command is received from the operator. When a result of the determination is YES, the processor 34 ends the flow in FIG. 6 and thus ends the flow in FIG. 3. On the other hand, when the processor 34 determines NO, the process returns to step S11.

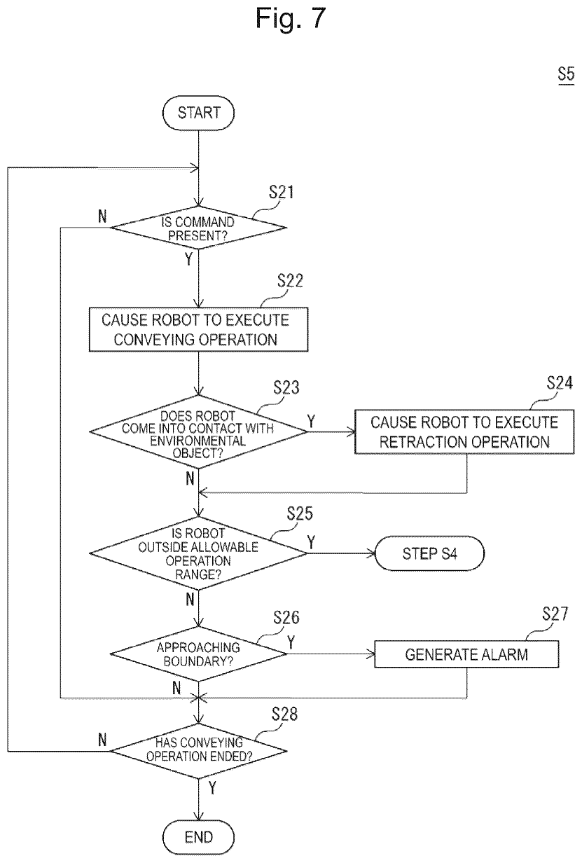

Referring back to FIG. 3, when the processor 34 determines NO in step S3, the processor 34 executes an in-range process in step S5. This step S5 will be described with reference to FIG. 7. In step S21, the processor 34 determines whether or not the command CM has been received, similar to step S11 described above, and the process proceeds to step S22 when the result of the determination is YES, whereas the process proceeds to step S28 when a result of the determination is NO.

In step S22, the processor 34 causes the robot 12 to execute the conveying operation CO, similar to step S13 described above. In the conveying operation CO, the robot 12 can move the workpiece W not only within the allowable operation range AR set in step S2 but also in a direction in which the robot moves toward the outside of the allowable operation range AR.

In step S23, the processor 34 functions as the contact determination unit 72, and determines whether or not the robot 12 has come into contact with the environmental object E based on the detection data Df, similarly to step S15 described above. The processor 34 proceeds to step S24 when the processor 34 determines YES, and proceeds to step S25 when the processor 34 determines NO.

In step S24, the processor 34 causes the robot 12 to execute the retraction operation RO, similar to step S16 described above. In the retraction operation RO, the processor 34 may move the robot 12 in the direction DR′ opposite to the moving direction DR of the conveying operation CO of step S22, or may move the robot 12 in the direction opposite to the direction of the contact force Fc obtained in the most recent step S23. Even when the robot 12 moves outside of the allowable operation range AR during the execution of the retraction operation RO, the processor 34 functions as the operation limiting unit 70 and permits the retraction operation RO.

In step S25, the processor 34 determines whether or not the robot 12 is outside of the allowable operation range AR at this time, similar to step S3 described above. When the processor 34 determines YES, the process proceeds to step S4 in FIG. 3, whereas when the processor 34 determines NO, the process proceeds to step S26. In step S26, the processor 34 determines whether or not the robot 12 executing the conveying operation CO has approached the boundary B of the allowable operation range AR. In particular, the processor 34 acquires the current position Pₙ (for example, coordinates Q1 or Q2) of the robot 12 at this point in time. At this time, since the robot 12 is executing the conveying operation CO within the allowable operation range AR, the current position Pₙ is inside of the allowable operation range AR.

Then, the processor 34 obtains the distance δₙ from the acquired current position Pₙ to the boundary B of the allowable operation range AR set in step S2. When the obtained distance δₙ is equal to or smaller than a predetermined threshold δₜₕ (δₙ≤δₜₕ), the processor 34 determines YES and proceeds to step S27. On the other hand, when δₙ>δₜₕ, the processor 34 determines NO and proceeds to step S28.

In step S27, the processor 34 functions as the alarm generating unit 68 and generates an alarm AL2. For example, the processor 34 generates an image or a voice alarm AL2 that is “Approaching the boundary of the allowable operation range.”. The processor 34 displays the generated alarm AL2 on the display device 40 (or 50) or outputs the alarm through a speaker (not illustrated).

Alternatively, the controller 14, the teaching device 16, or the robot 12 may be provided with a light emitting device (a rotary lamp, an LED lamp, or the like), and the processor 34 may generate the alarm AL2 that causes the light emitting device to emit light. Alternatively, the teaching device 16 or the robot 12 may be provided with a vibrator (or tactile generation device), and the processor 34 may generate an alarm AL2 that vibrates the vibrator.

Thus, in the present embodiment, the processor 34 functions as the alarm generating unit 68, and generates the alarm AL2 when the robot 12 executing the conveying operation CO within the allowable operation range AR approaches the boundary B of the allowable operation range AR. In step S28, the processor 34 determines whether or not the conveying operation CO has ended, similar to step S18 described above. When the result of the determination is YES, the processor 34 ends the flow in FIG. 7, and thus ends the flow in FIG. 3. On the other hand, when the processor 34 determines NO, the process returns to step S21.

As described above, in the present embodiment, the processor 34 functions as an information acquisition unit 62, the range setting unit 64, the range determination unit 66, the alarm generating unit 68, the operation limiting unit 70, and the contact determination unit 72, and limits the operation (specifically, the conveying operation CO) to be executed by the robot 12. Therefore, the information acquisition unit 62, the range setting unit 64, the range determination unit 66, the alarm generating unit 68, the operation limiting unit 70, and the contact determination unit 72 constitute a device 60 (FIG. 2) that limits the operation of the robot 12.

In the device 60, the information acquisition unit 62 acquires information IF1 (a value of the load L, the coordinate Qg, and the like) of the load L (the weight WG, the inertia IN, the moment MO, the load torque TQ, and the like) applied to the robot 12 (step S1). Further, the range determination unit 66 determines whether or not the robot 12 gripping the workpiece W is outside of the allowable operation range AR (for example, the allowable operation range AR1, AR2, or AR3) determined in response to the load L based on the information IF1 acquired by the information acquisition unit 62 (steps S3, S17, and S 25).

When the range determination unit 66 determines that the robot 12 is outside of the allowable operation range AR (that is, YES in step S3, S17, or S25), the operation limiting unit 70 permits the operation CO of the robot 12 moving toward the inside of the allowable operation range AR (step S13), while prohibiting the operation CO of the robot 12 moving away from the allowable operation range AR (a loop of steps S11, S12, and S14).

Here, for example, when the conveying operation CO is taught to the robot 12, there may be a case in which the robot 12 is caused to grip the workpiece W with the overload L outside of the allowable operation range AR. In such a case, when any operation of the robot 12 is prohibited, teaching work has to be stopped and work efficiency is degraded. On the other hand, even when the robot 12 is outside of the allowable operation range AR, the safety of the robot 12 is likely to be ensured in the operation of the robot 12 moving toward the allowable operation range AR.

According to the device 60, even when the robot 12 is outside of the allowable operation range AR, the operation CO in which the robot 12 moves toward the allowable operation range AR is permitted, which makes it possible to improve the work efficiency while ensuring the safety of the robot 12. On the other hand, when the robot 12 is outside of the allowable operation range AR and operates in the direction in which the robot moves away from the allowable operation range AR, there is a high possibility that the components of the robot 12 are damaged due to the overload. According to the device 60, it is possible to prevent the robot 12 from being damaged by prohibiting the operation CO in which the robot moves away from the allowable operation range AR.

Further, in the device 60, when the information acquisition unit 62 acquires the information IF1, the range setting unit 64 determines the allowable operation range AR (AR1, AR2, or AR3) in response to the load L indicated by the information IF1 (step S2). According to this configuration, since the allowable operation range AR in response to the load L applied to the robot 12 can be appropriately determined, it is possible to prevent the allowable operation range AR from being set to be excessively wide or excessively narrow. This makes it possible to more effectively improve the work efficiency while more effectively ensuring the safety of the robot 12.

Further, in an example of the device 60, a plurality of allowable operation ranges AR1, AR2, and AR3 (FIG. 4) different from each other are stored in advance in the memory 36 (or 46) in association with the load L, and the range setting unit 64 selects the allowable operation range AR1, AR2, or AR3 corresponding to the load L indicated by the information IF1 from the plurality of allowable operation ranges AR1, AR2, and AR3 (step S2). According to this configuration, it is possible to determine the allowable operation range AR1, AR2, or AR3 in response to the load L using a quick and simple algorithm.

In another example of the device 60, the range setting unit 64 performs a predetermined calculation (for example, a calculation of an equation d=f(L)) using the load L indicated by the information IF1, thereby obtaining the allowable operation range AR in response to the load L. According to this configuration, it is possible to quickly determine the allowable operation range AR optimal for the load L by appropriately designing the calculation equation d=f(L).

Further, in the device 60, the alarm generating unit 68 generates the alarm AL1 when the operation limiting unit 70 prohibits the operation CO (step S14). With this configuration, the operator can intuitively recognize that the operation CO in a direction in which the robot moves away from the allowable operation range AR is impossible. On the other hand, the alarm generating unit 68 executes the operation CO within the allowable operation range AR (step S22), and when the robot 12 approaches the boundary B of the allowable operation range AR, the alarm generating unit 68 generates the alarm AL2 (step S27). According to this configuration, the operator can intuitively recognize that the robot 12 is approaching the boundary B, and therefore the robot 12 can be prevented from moving outside of the allowable operation range AR.

Further, in the device 60, the contact determination unit 72 determines whether or not the robot 12 has come into contact with the environmental object E based on the detection data Df of the force sensor 32 that detects the external force F applied to the robot 12 (steps S15 and S23). When the contact determination unit 72 determines that the robot 12 has come into contact with the environmental object E (YES in step S15 or S23), the operation limiting unit 70 permits the retraction operation RO of the robot 12 moving toward the outside of the allowable operation range AR in order to eliminate the contact. According to this configuration, even when the robot 12 comes into contact with an environmental object (for example, the operator) during the execution of the operation CO, damage to the robot 12 or the environmental object E can be prevented.

In the above-described embodiment, the case in which the operator teaches the conveying operation CO to the robot 12 has been described. However, the present disclosure is not limited thereto, and the processor 34 may execute the flow of FIG. 3 when the robot 12 automatically executes the conveying operation CO in accordance with an operation program PG1 for the conveying operation CO.

In this case, the processor 34 receives an operation command CMo from the command code defined in the operation program PG1 as the command CM in step S11 or S21 described above. Also, in the above-described embodiment, the robot 12 may be caused to continuously execute the conveying operation CO for conveying a plurality of types of workpieces W₁, W₂, . . . , Wₘwith different loads L. In this case, the processor 34 may execute the flow of FIG. 3 each time a new workpiece Wₖ is gripped.

In the above-described embodiment, the case in which the processor 34 (range setting unit 64) determines the allowable operation range AR in response to the load L in step S2 has been described. However, the present disclosure is not limited thereto, and a predetermined allowable operation range AR may be determined in advance. For example, it is assumed that the conveying operation CO of conveying the plurality of workpieces W₁, W₂, . . . , Wₘ with different loads L is performed as described above.

In this case, it is assumed that a load Lk of the workpiece Wₖ is the largest among the loads L of the plurality of workpieces W₁, W₂, . . . , Wₘ. In this case, the allowable operation range AR corresponding to a maximum load Lₖ (for example, the allowable operation range AR1 in FIG. 4) may be determined in advance in the operation parameters OP. That is, in this case, step S2 can be omitted from the flow in FIG. 3, and the range setting unit 64 can be omitted from the device 60.

Further, for example, when it is desired to determine an outline of the conveying operation CO without causing the robot 12 to grip the actual workpiece W during teaching, the allowable operation range AR corresponding to the maximum load Lₖ is determined in advance, making it unnecessary for the operator to be aware of the allowable operation range AR corresponding to the workpiece W each time. As a result, when the robot 12 is caused to perform the conveying operation CO after teaching, it is possible to prevent the robot 12 from becoming unable to move due to an overload.

Further, step S14 may be omitted from the flow of FIG. 6, and step S27 may be omitted from the flow of FIG. 7. That is, in this case, the alarm generating unit 68 can be omitted from the device 60. Further, steps S15 and S16 may be omitted from the flow of FIG. 6, and steps S23 and S24 may be omitted from the flow of FIG. 7. That is, in this case, the contact determination unit 72 may be omitted from the device 60.

The processor 34 may execute the flow illustrated in FIG. 3 according to the computer program PG2 stored in the memory 36 (or 46) in advance. Further, the functions of the device 60 (that is, the information acquisition unit 62, range setting unit 64, range determination unit 66, alarm generating unit 68, operation limiting unit 70, and contact determination unit 72) executed by the processor 34 may be functional modules realized by the computer program PG2.

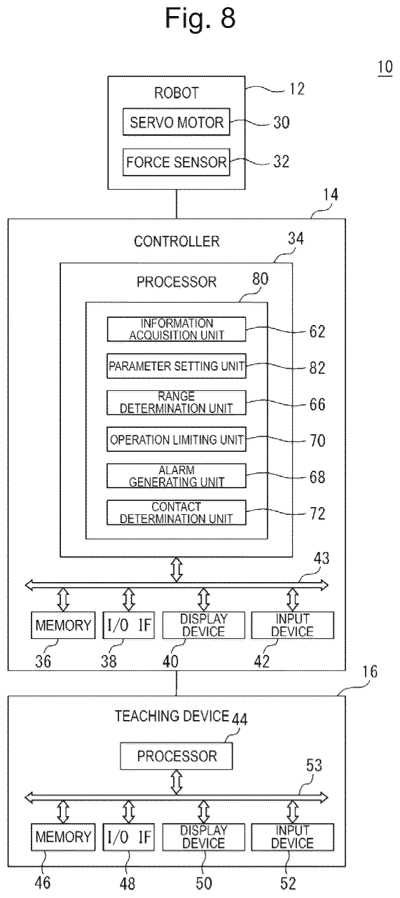

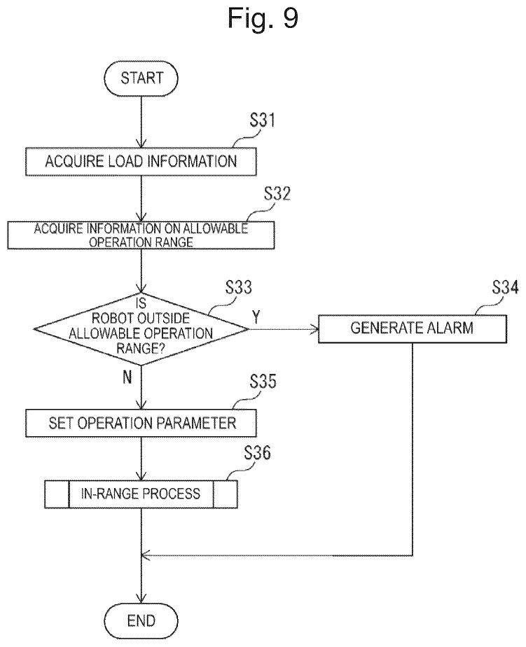

Next, other functions of the robot system 10 will be described with reference to FIGS. 8 and 9. The processor 34 of the controller 14 illustrated in FIG. 8 executes the flow illustrated in FIG. 9. The processor 34 starts the flow illustrated in FIG. 9 when the workpiece W is gripped by the robot hand 28, similar to the flow of FIG. 3. In step S31, the processor 34 functions as the information acquisition unit 62 and acquires the information IF1 on the load L, similar to step S1 described above.

In step S32, the processor 34 acquires information IF2 of the allowable operation range AR. As an example, the processor 34 determines the allowable operation range AR in response to the load L indicated by the information IF1 acquired in step S1 in a manner similar to step S2 in FIG. 3. For example, the plurality of allowable operation ranges AR1, AR2, and AR3 are stored in the database 100 in advance, and the processor 34 selects the allowable operation range AR corresponding to the load L from the plurality of allowable operation ranges AR1, AR2, and AR3.

Alternatively, the processor 34 may obtain the allowable operation range AR in response to the load L by performing a predetermined calculation (for example, a calculation of an equation d=f(L)) using the load L. The processor 34 acquires the information IF2 of the allowable operation range AR determined in response to the load L (for example, the above-described distance d, or the coordinate in the robot coordinate system C1 of the boundary B of the allowable operation range AR). As another example, the predetermined allowable operation range AR may be determined in advance and stored in the memory 36 (or 46), and the processor 34 may acquire the information IF2 of the allowable operation range AR by reading the information IF2 from the memory 36.

In step S33, the processor 34 functions as the range determination unit 66 and determines whether or not the robot 12 gripping the workpiece W is outside of the allowable operation range AR. Specifically, the processor 34 determines whether or not the current position Pₙ (the coordinate Q1, Q2, or the like) of the robot 12 at this time point is outside of the allowable operation range AR indicated by the information IF2 based on the information IF2 acquired in the step S32. The processor 34 proceeds to step S34 when determining YES, and proceeds to step S35 when determining NO.

In step S34, the processor 34 functions as the alarm generating unit 68 and generates an alarm AL3. For example, the processor 34 generates an image or sound alarm AL3 stating “The robot is overloaded and cannot start an operation. Please reset the operation parameters related to the load”. The processor 34 displays the generated alarm AL3 on the display device 40 (or 50) or outputs the alarm AL3 through a speaker (not shown). The processor 34 ends the flow of FIG. 9.

On the other hand, when a result of the determination in step S33 is NO, the processor 34 sets, in step S35, the operation parameter OP based on the information IF1 acquired in step S31. The operation parameter OP is a parameter that defines operation conditions for causing the robot 12 to execute the conveying operation CO, and includes, for example, various conditions such as the information IF1 on the load L, the information IF2 on the allowable operation area AR determined in response to the load L, and the velocity V and acceleration a of the robot 12.

Here, in the present embodiment, when at least one of the operation parameters OP (for example, the allowable operation area AR determined in response to the load L and various conditions such as the velocity V and the acceleration α) is not formally set (for example, not registered in the parameter database DB), the processor 34 is not capable of executing the conveying operation CO.

In step S35, the processor 34 officially sets (for example, registers in the parameter database DB) the information IF1 on the load L acquired in step S31 and the information IF2 of the allowable operation range AR acquired in step S32 as the operation parameters OP, together with the various conditions such as the velocity V and the acceleration α. As a result, the processor 34 is able to execute the conveying operation CO according to the operation parameters OP. Thus, in the present embodiment, the processor 34 functions as the parameter setting unit 82 (FIG. 8) that sets the operation parameters OP based on the information IF1.

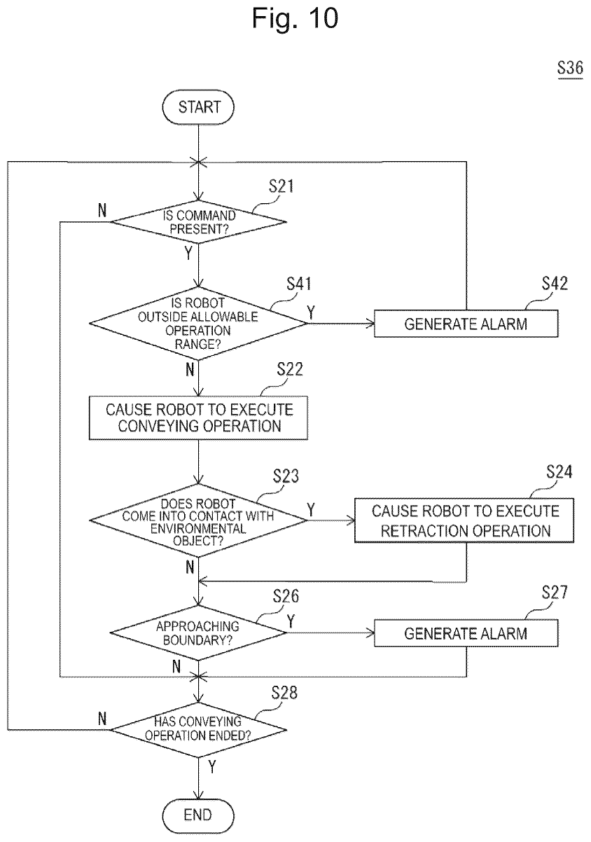

In step S36, the processor 34 executes the in-range process. This step S36 will be described with reference to FIG. 10. In the flow illustrated in FIG. 10, the same step numbers are assigned to processes similar to those in the flow of FIG. 7, and duplicated descriptions will be omitted. When a result of the determination in step S21 is YES, the processor 34 functions, in step S41, as the range determination unit 66 and determines whether or not the robot 12 will move outside of the allowable operation range AR set as the operation parameter OP in step S35 when the robot 12 is caused to execute the conveying operation CO in accordance with the command CM received in the most recent step S21.

Specifically, the processor 34 obtains the target position Pₙ +1 in accordance with the command CM, as in step S12 described above. The processor 34 determines whether or not the obtained target position Pₙ₊₁ is outside of the allowable operation range AR. When the target position Pₙ₊₁ is outside of the allowable operation range AR, the processor 34 determines YES and proceeds to step S42. On the other hand, when the target position Pₙ₊₁ is inside of the allowable operation range AR, the processor 34 determines NO, proceeds to step S22, and causes the robot 12 to execute the conveying operation CO in accordance with the command CM.

When a result of the determination in step S41 is YES, the processor 34 functions as the alarm generating unit 68 to generate the alarm AL4 in step S42. For example, the processor 34 generates an image or sound alarm AL4 stating “Since the robot is outside of the allowable operation range, an operation in the direction cannot be executed”. The processor 34 displays the generated alarm AL4 on the display device 40 (or 50) or outputs the alarm AL4 through a speaker (not illustrated). The processor 34 returns to step S21.

Thus, when the processor 34 determines NO in step S41 (that is, when the robot 12 moves within the allowable operation range AR), the processor 34 permits the conveying operation CO in step S22. On the other hand, even when the processor 34 continuously receives the command C in step S21, the processor 34 prohibits the execution of the conveying operation CO in step S22 by repeating the loop of the steps S21, S41, and S42 while the processor 34 determines YES in step S41.

That is, the processor 34 functions as the operation limiting unit 70 that permits the conveying operation CO of the robot 12 moving within the allowable operation range AR, while prohibiting the conveying operation CO of the robot 12 moving toward outside of the allowable operation range AR. After step S22, the processor 34 functions as the contact determination unit 72 and the alarm generating unit 68, and sequentially executes steps S23, S24, S26, S27, and S28 described above.

As described above, in the flow of FIG. 9, when the processor 34 determines YES in step S33, the processor 34 does not set the operation parameter OP of step S35. In this case, the processor 34 receives an input of the information IF1 on a new load L from the operator in step S31, for example, and then executes step S35 to set the operation parameter OP when a result of the determination is NO in step S33.

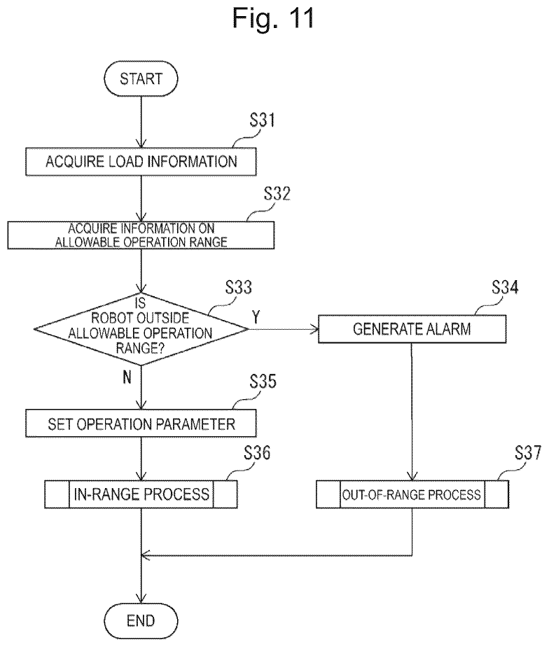

Alternatively, the processor 34 sets the operation parameter OP when the processor 34 receives the command C after the processor 34 proceeds to step S37 (out-of-range process) in FIG. 11 to be described later. Thus, in the present embodiment, the processor 34 functions as the parameter setting unit 82, and when the processor 34 determines YES in step S33, the processor 34 suspends (in other words, temporarily prohibits) the setting of the operation parameter OP until a predetermined condition (for example, reacquisition of the information IF2 of the load L or transition to the out-of-range process) is satisfied.

When the processor 34 determines YES in step S33 to suspend a setting of the operation parameter OP, the processor 34 may set a flag FG indicating that the setting of the operation parameter OP is suspended to be valid. While the flag FG is valid, the processor 34 is not able to set the operation parameter OP. When the processor 34 determines NO in step S33, the processor 34 may invalidate the flag FG.

As described above, in the present embodiment, the processor 34 functions as the information acquisition unit 62, the range determination unit 66, the alarm generating unit 68, the operation limiting unit 70, the contact determination unit 72, and the parameter setting unit 82, to set the operation parameter OP of the robot 12 that performs a predetermined operation (specifically, the conveying operation CO). Therefore, the information acquisition unit 62, the range determination unit 66, the alarm generating unit 68, the operation limiting unit 70, the contact determination unit 72, and the parameter setting unit 82 constitute a device 80 (FIG. 8) that sets the operation parameter OP.

In the device 80, the information acquisition unit 62 acquires the information IF1 on the load L (step S31), and the range determination unit 66 determines whether or not the robot 12 gripping the workpiece W is outside of the allowable operation range AR determined in response to the load L indicated by the information IF1 (step S33). The parameter setting unit 82 sets the operation parameter OP to cause the robot 12 to execute the operation CO based on the information IF1 acquired by the information acquisition unit 62 (step S35). Here, when the range determination unit 66 determines that the robot 12 is outside of the allowable operation range AR (YES in step S33), the parameter setting unit 82 suspends the setting of the operation parameter OP.

In the related art, the operation parameter OP is automatically set in response to the acquisition of the information IF1 on the load L. In contrast, in the device 80, even when the information acquisition unit 62 acquires the information IF1 in step S31, when the result of the determination is YES in step S33, the setting of the operation parameter OP itself is not performed, and thus the operation CO is prohibited. According to this configuration, it is possible to reliably prohibit the robot 12 outside of the allowable operation range AR executing the operation CO in an overload state. As a result, the safety of the robot 12 can be reliably ensured.

Further, in the device 80, when the range determination unit 66 determines that the robot 12 is inside of the allowable operation range AR (NO in step S33), the parameter setting unit 82 sets the allowable operation range AR as the operation parameter OP (step S35). The operation limiting unit 70 permits the conveying operation CO of the robot 12 moving within the allowable operation range AR (step S22 in FIG. 10), while prohibiting the conveying operation CO of the robot 12 moving toward outside of the allowable operation range AR (a loop of steps S21, S41, and S42 in FIG. 10). With this configuration, it is possible to prevent the robot 12 from moving toward outside of the allowable operation range AR and becoming overloaded, and thus, to effectively ensure the safety of the robot 12.

Further, in the device 80, the alarm generating unit 68 generates the alarm AL3 when the range determination unit 66 determines that the robot 12 is outside of the allowable operation range AR (YES in step S33) (step S34). According to this configuration, the operator can intuitively recognize that the setting of the operation parameter and the operation CO cannot be executed due to the overload.

In the above-described embodiment, a case in which the information IF1 on the load L and the information IF2 on the allowable operation area AR are set as the operation parameters OP has been described. However, the present disclosure is not limited thereto, and the operation parameters OP may not include the information IF1 and IF2, and only the various conditions such as the velocity V and the acceleration α may be set as the operation parameters OP.

Further, steps S41 and S42 may be omitted from the flow in FIG. 10. That is, in this case, the operation limiting unit 70 can be omitted from the device 80. Also, step S34 may be omitted from the flow of FIG. 9, and steps S42 and S27 may be omitted from the flow of FIG. 10. That is, in this case, the alarm generating unit 68 may be omitted from the device 80. Also, steps S23 and S24 may be omitted from the flow of FIG. 10. That is, in this case, the contact determination unit 72 may be omitted from the device 80.

The processor 34 may execute the flow illustrated in FIG. 9 according to the computer program PG3 stored in the memory 36 (or 46) in advance. Also, the functions of the device 80 (that is, the information acquisition unit 62, the range determination unit 66, the alarm generating unit 68, the operation limiting unit 70, the contact determination unit 72, and the parameter setting unit 82) executed by the processor 34 may be functional modules realized by the computer program PG3.

Next, another example of the operation flow executed by the robot system 10 illustrated in FIG. 8 will be described with reference to FIG. 11. The flow illustrated in FIG. 11 differs from the flow illustrated in FIG. 9 in the following process. That is, in the flow illustrated in FIG. 11, after step S34, the processor 34 proceeds to the out-of-range process of step S37.

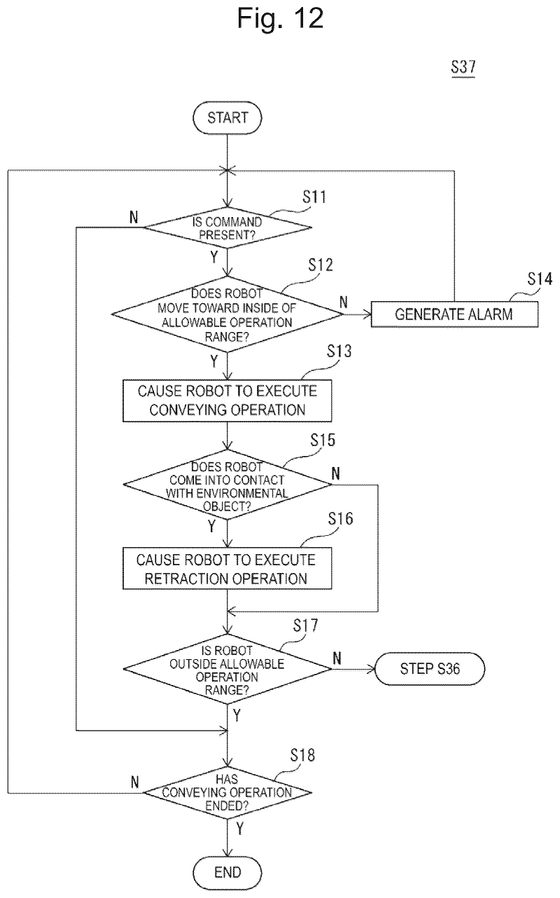

This step S37 is illustrated in FIG. 12. When the process proceeds to step S37, the processor 34 may invalidate the flag FG described above, and set the information IF1 on the load L acquired in step S31 in FIG. 11 and the information IF2 of the allowable operation range AR acquired in step S32 as the operation parameters OP together with various conditions such as the velocity V and the acceleration α.

In step S37 illustrated in FIG. 12, the processor 34 executes steps S11 to S18 as in step S6 in FIG. 6, but when a result of the determination is NO in step S17, the process proceeds to step S36 in FIG. 11. In the flow of FIG. 11, step S4 illustrated in FIG. 6 may be executed instead of step S36, and step S5 illustrated in FIG. 7 may be executed instead of step S37.

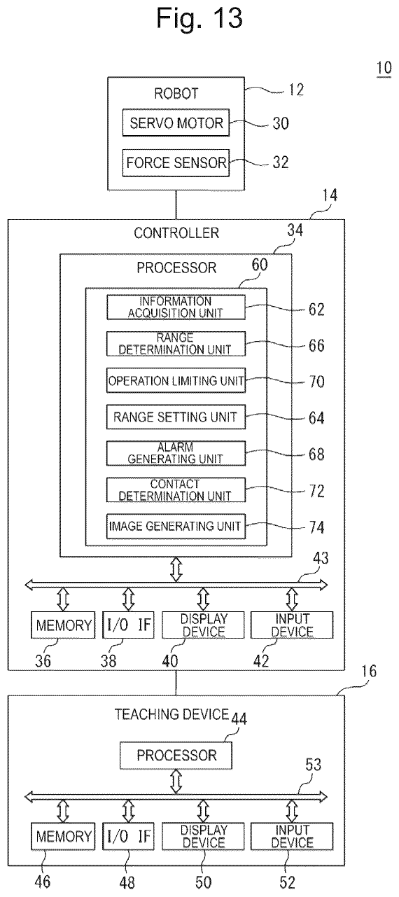

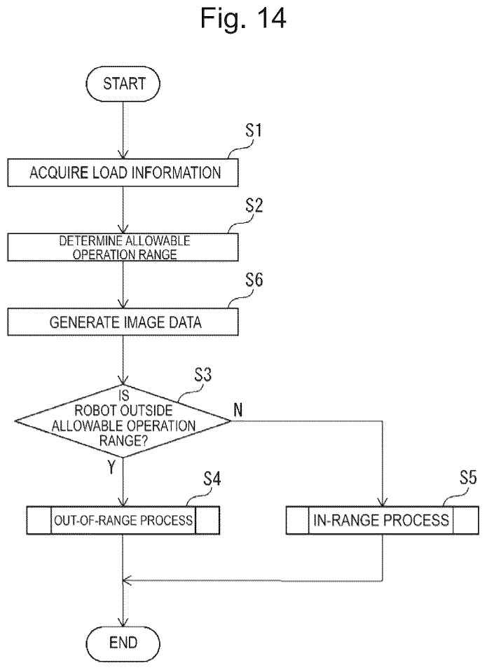

Next, further other functions of the robot system 10 will be described with reference to FIG. 13. In the present embodiment, the processor 34 functions as the above-described device 60, and the device 60 further includes an image generating unit 74. Hereinafter, a function of the image generating unit 74 will be described with reference to FIG. 14. A flow illustrated in FIG. 14 differs from the flow of FIG. 3 in step S6.

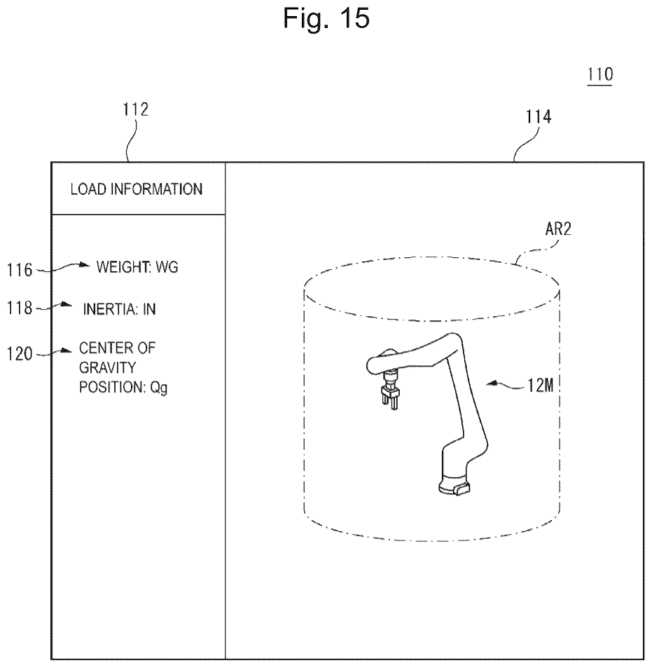

Specifically, after step S2, the processor 34 generates, in step S6, image data 110 for displaying the allowable operation range AR determined in step S2. An example of the image data 110 is illustrated in FIG. 15. In the example illustrated in FIG. 15, the image data 110 includes an operation parameter display area 112 and a model display area 114. The operation parameter display area 112 displays the operation parameter OP set at this time.

In the example illustrated in FIG. 15, the information IF1 (to be specific, the weight WG, the inertia IN, and the center of gravity position (coordinates Qg) of the load L is displayed as the operation parameter OP in the operation parameter display area 112. The moment MO and the load torque TQ may be displayed as the information IF1 on the load L. Further, various conditions such as the velocity V and the acceleration α may be displayed as the operation parameter OP in the operation parameter display area 112.

In the model display area 114, a robot model 12M (for example, a 3DCAD model) obtained by modeling the robot 12 and the allowable operation range AR determined in step S2 are three dimensionally displayed. FIG. 15 illustrates an example in which the allowable operation range AR2 is displayed. Thus, in the present embodiment, the processor 34 functions as an image generating unit 74 that generates image data 110 for displaying the allowable operation range AR.

The processor 34 displays the generated image data 110 on the display device 40 (or 50). The processor 34 may acquire the current position Pₙ of the robot 12 at the start of step S6 and display the robot model 12M disposed at the current position Pₙ in the model display area 114. According to this configuration, the operator can easily confirm the allowable operation range AR2 determined in step S2 and a positional relationship of the robot 12 (to be specific, the robot hand 28) with respect to the boundary B. After step S32 in FIG. 9, step S6 may be executed to generate the image data 110 for displaying the allowable operation range AR determined in step S32. In other words, in this case, the device 80 in FIG. 8 further includes the image generating unit 74.

In the above-described embodiment, the case in which the allowable operation range AR is the allowable position range that defines the allowable range of the position P of the robot 12 has been described. However, the present disclosure is not limited thereto, and the allowable operation range AR may have an allowable orientation range that defines an allowable range of an orientation O of the robot 12 (to be specific, the robot hand 28 or the tool coordinate system C2) instead of the allowable position range (or in addition to the allowable position range).

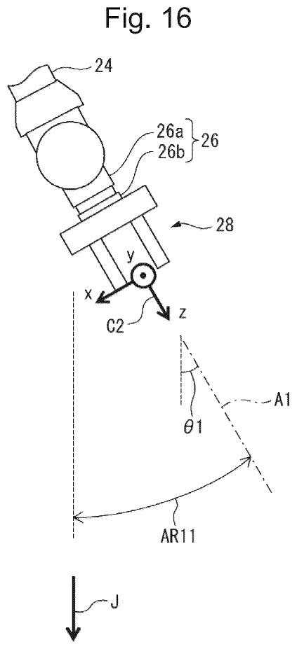

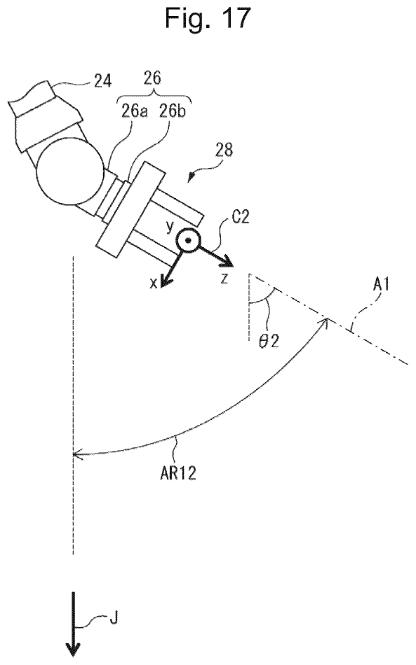

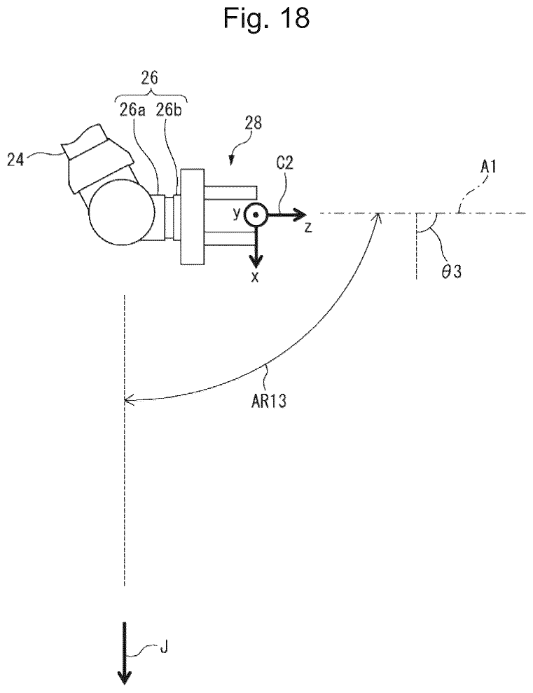

The allowable operation range AR as the allowable orientation range will be described with reference to FIGS. 16 to 18. In the example illustrated in FIGS. 16 to 18, the allowable operation range AR (allowable orientation range) is determined as an angle θ of the wrist axis A1 of the robot 12 from a vertical direction J. To be specific, the allowable operation range AR includes the allowable operation range AR11 (FIG. 16), the allowable operation range AR12 (FIG. 17) wider than the allowable operation range AR11, and the allowable operation range AR13 (FIG. 18) wider than the allowable operation range AR12.

The allowable operation range AR11 is applied to a range where the angle θ is θ≤θ1 (for example, θ1=30°) and the load L is L≥L1 (for example, L1=20 [kg]). On the other hand, the allowable operation range AR12 is applied to a range in which the angle θ is θ≤θ2 (for example, θ2=60°>θ1) and the load L is L2≤L<L1 (for example, L2=10 [kg]). Further, the allowable operation range AR13 is applied to a range in which the angle θ is θ≤θ3 (for example, θ3=90°>θ2) and the load L is 0≤L<L2. Any number of allowable operation ranges AR may be determined as the allowable orientation range.

In step S2 or S32 described above, the processor 34 may determine the allowable orientation range AR11, AR12, or AR13 as the allowable orientation range based on the information IF1 on the load L. The processor 34 may determine the allowable position ranges AR1, AR2, and AR3 and the allowable orientation ranges AR11, AR12, and AR13 as allowable orientation ranges AR.

In this case, in step S2 or S32 described above, the processor 34 may determine the allowable position range AR1, AR2, or AR3 and the allowable orientation range AR11, AR12, or AR13 as the allowable orientation range AR, and execute step S3, S12, S17, S25, S33, or S41 described above for each of the determined allowable position range AR1, AR2, or AR3 and the allowable orientation range AR11, AR12, or AR13.

The processor 34 may have functions of the device 60 (the information acquisition unit 62, the range setting unit 64, the range determination unit 66, the alarm generating unit 68, the operation limiting unit 70, the contact determination unit 72, and the image generating unit 74) and functions of the device 80 (the information acquisition unit 62, the range determination unit 66, the alarm generating unit 68, the operation limiting unit 70, the contact determination unit 72, and the parameter setting unit 82).

Further, in the above-described embodiment, the case in which the functions of the device 60 (the information acquisition unit 62, the range setting unit 64, the range determination unit 66, the alarm generating unit 68, the operation limiting unit 70, the contact determination unit 72, and the image generating unit 74) are implemented in the controller 14 has been described. However, at least one of the functions of the device 60 may be implemented in another computer (for example, the teaching device 16). In this case, the processor (processor 44) of the other computer (teaching device 16) functions as the device 60. Similarly, at least one of the functions of the device 80 (the information acquisition unit 62, the range determination unit 66, the alarm generating unit 68, the operation limiting unit 70, the contact determination unit 72, and the parameter setting unit 82) may be implemented in another computer (for example, the teaching device 16).

In the above-described embodiment, the flows of FIGS. 3, 9, 11, and 14 are executed by the actual robot 12. However, the present disclosure is not limited thereto, and the processor 34 may function as the device 60 or 80 and cause the robot model 12M disposed in the virtual space to simulatively execute the flow of FIGS. 3, 9, 11, or 14 (that is, simulation). Further, the robot 12 is not limited to the vertical articulated robot, and may be any type of robot capable of conveying the workpiece W, such as a horizontal articulated robot or a parallel link robot. Further, the robot 12 may be installed at any place such as a wall surface or a ceiling of the work cell.

In the above-described embodiment, the robot 12 performs the conveying operation CO as the predetermined operation. However, the robot 12 is not limited thereto, and may execute, as the predetermined operation, a welding operation WO of welding the workpiece W using a plurality of types of welding guns GN (not shown) having different weights. In this case, the robot 12 sequentially attaches and detaches various types of the welding guns GN to and from the wrist flange 26b in a series of the welding operations WO. In this case, the load L applied from the welding gun GN to the robot 12 changes according to the progress of the welding operation WO.

When the processor 34 (or 44) performs such a welding operation WO, the processor 34 (or 44) may execute a flow similar to the flow of FIGS. 3, 9, 11, or 14. In this case, for example, the processor 34 (or 44) may start the flow of FIGS. 3, 9, 11, or 14 when the welding gun GN to be attached to the wrist flange 26b is replaced at a predetermined tool replacement place, and execute the flow based on the load L applied from the welding gun GN to the robot 12. Thus, the concept of the present disclosure is not limited to the conveying operation CO, and can be applied to any other operation in which the load L is applied to the robot 12.

The present disclosure has been described in detail above, but is not limited to the above-described individual embodiments. These embodiments may be added, replaced, modified, partially deleted, or the like, to the extent not deviating from the gist of the present disclosure or from the gist of the present disclosure derived from the contents described in the claims and equivalents thereof. These embodiments may also be combined. For example, in the above-described embodiments, the order of each operation and the order of each process are illustrated as examples and are not limited to these orders. The same applies when values or formula are used in the description of the above-described embodiments.

The Present Disclosure Discloses the Following Aspects.

### Aspect 1

A device 60 configured to limit an operation (for example, the conveying operation CO) of a robot 12, the device 60 comprising: an information acquisition unit 62 configured to acquire information IF1 on a load L applied to the robot 12; a range determination unit 66 configured to determine whether or not the robot 12 is outside of an allowable operation range AR (AR1, AR2, AR3, AR11, AR12, or AR13) which is determined in response to the load L, based on the information IF1 acquired by the information acquisition unit 62; and an operation limiting unit 70 configured to permit the operation of the robot 12 moving toward inside of the allowable operation range AR while prohibiting the operation of the robot 12 moving away from the allowable operation range AR, when the range determination unit 66 determines that the robot 12 is outside of the allowable operation range AR.

### Aspect 2

The device 60 of aspect 1, further comprising a range setting unit 64 configured to determine the allowable operation range AR in response to the load L indicated by the information IF1 when the information acquisition unit 62 acquires the information IF1.

### Aspect 3

The device 60 of aspect 2, wherein a plurality of the allowable operation ranges AR1, AR2, AR3, AR11, AR12, and AR13 different from each other are stored in advance in association with the load L, and wherein the range setting unit 64 is configured to select the allowable operation range AR1, AR2, or AR3, or AR11, AR12, or AR13 corresponding to the load L indicated by the information IF1, from the plurality of allowable operation ranges AR1, AR2, AR3, AR11, AR12, and AR13.

### Aspect 4

The device 60 of aspect 2, wherein the range setting unit 64 is configured to obtain the allowable operation range AR in response to the load L indicated by the information IF1 by performing a predetermined calculation using the load L.

### Aspect 5

The device 60 of any one of aspects 2 to 4, further comprising an image generating unit 74 configured to generate image data 110 displaying the allowable operation range AR determined by the range setting unit 64.

### Aspect 6

The device 60 of any one of aspects 1 to 5, further comprising an alarm generating unit 68 configured to generate an alarm AL1 when the operation limiting unit 70 prohibits the operation of the robot 12 moving away from the allowable operation range AR.

### Aspect 7

A device 80 configured to set an operation parameter OP of a robot 12 configured to perform a predetermined operation (for example, a conveying operation CO), the device 80 comprising: an information acquisition unit 62 configured to acquire information IF1 on a load L applied to the robot 12; a parameter setting unit 82 configured to set the operation parameter OP to cause the robot 12 to execute the predetermined operation, based on the information IF1 acquired by the information acquisition unit 62; and a range determination unit 66 configured to determine whether or not the robot 12 is outside of an allowable operation range AR which is determined in response to the load L indicated by the information IF1 acquired by the information acquisition unit 62, wherein the parameter setting unit 82 is configured to suspend the setting of the operation parameter OP when the range determination unit 66 determines that the robot 12 is outside of the allowable operation range AR.

### Aspect 8

The device 80 of aspect 7, wherein the operation parameter OP includes at least one of the load L and the allowable operation range AR.

### Aspect 9

The device 80 of aspect 8, wherein the parameter setting unit 82 is configured to set the allowable operation range AR as the operation parameter OP when the range determination unit 66 determines that the robot 12 is inside of the allowable operation range AR, and wherein the device 80 further comprises an operation limiting unit 70 configured to permit the operation of the robot 12 moving within the allowable operation range AR while prohibiting the operation of the robot 12 moving to outside of the allowable operation range AR.

### Aspect 10

The device 80 of any one of aspects 7 to 9, further comprising an alarm generating unit 68 configured to generate an alarm AL3 when the range determination unit 66 determines that the robot 12 is outside of the allowable operation range AR.

### Aspect 11

The device 60 or 80 of any of aspects 1 to 10, wherein the allowable operation range AR includes at least one of: allowable position ranges AR1, AR2, and AR3 defining an allowable range of a position P of the robot 12; and an allowable orientation range AR11, AR12, and AR13 defining an allowable range of an orientation O of the robot 12.

### Aspect 12

The device 60 or 80 of aspect 11, wherein the allowable orientation range AR11, AR12 and AR13 is determined as an angle θ of a wrist axis A1 of the robot 12 from a vertical direction J.

### Aspect 13

The device 60 or 80 of any one of aspects 1 to 12, further comprising an alarm generating unit 68 configured to generate an alarm AL2 when the robot 12 executing the operation within the allowable operation range AR approaches a boundary B of the allowable operation range AR.

### Aspect 14

The device 60 or 80 of aspect 1 or 9, further comprising a contact determination unit 72 configured to determine whether or not the robot 12 comes into contact with an environmental object E, based on detection data Df of a force sensor 32 configured to detect an external force F applied to the robot 12, wherein the operation limiting unit 70 is configured to permit a retraction operation RO of the robot 12 moving toward outside of the allowable operation range AR to eliminate the contact, when the contact determination unit 72 determines that the robot 12 comes into contact with the environmental object E.

### Aspect 15

A method of limiting an operation (for example, a conveying operation CO) of a robot 12, the method comprising: acquiring, by a processor 34, information IF1 on a load L applied to the robot 12; determining, by the processor 34, whether or not the robot 12 is outside of an allowable operation range AR which is determined in response to the load L, based on the acquired information IF1; and permitting, by the processor 34, the operation of the robot 12 moving toward inside of the allowable operation range AR while prohibiting the operation of the robot moving away from the allowable operation range AR, when determining that the robot 12 is outside of the allowable operation range AR.

### Aspect 16

A method of setting an operation parameter OP of a robot 12 configured to perform a predetermined operation, the method comprising: acquiring, by a processor 34, information IF1 on a load L applied from a workpiece W to the robot 12; setting, by the processor 34, the operation parameter OP to cause the robot 12 to execute the predetermined operation, based on the acquired information IF1; determining, by the processor 34, whether or not the robot 12 is outside of an allowable operation range AR which is determined in response to the load L indicated by the acquired information IF1; and suspending, by the processor 34, the setting of the operation parameter OP when determining that the robot 12 is outside of the allowable operation range AR.

### Aspect 17

A computer program PG2 or PG3 that causes a processor 34 to execute the method of aspect 15or 16.

### REFERENCE SIGNS LIST

10 Robot system
12 Robot
14 Controller
16 Teaching device
28 Robot hand
32 Force sensor
34, 44 Processor
60, 80 Device
62 Information acquisition unit
64 Range setting unit
66 Range determination unit
68 Alarm generating unit
70 Operation limiting unit
72 Contact determination unit
74 Image generating unit
82 Parameter setting unit

1. A device configured to limit an operation of a robot, the device comprising:
an information acquisition unit configured to acquire information on a load applied to the robot;
a range determination unit configured to determine whether or not the robot is outside of an allowable operation range which is determined in response to the load, based on the information acquired by the information acquisition unit; and
an operation limiting unit configured to permit the operation of the robot moving toward inside of the allowable operation range while prohibiting the operation of the robot moving away from the allowable operation range, when the range determination unit determines that the robot is outside of the allowable operation range.

2. The device of claim 1, further comprising a range setting unit configured to determine the allowable operation range in response to the load indicated by the information when the information acquisition unit acquires the information.

3. The device of claim 2, wherein a plurality of the allowable operation ranges different from each other are stored in advance in association with the load, and
wherein the range setting unit is configured to select the allowable operation range corresponding to the load indicated by the information, from the plurality of allowable operation ranges.

4. The device of claim 2, wherein the range setting unit is configured to obtain the allowable operation range in response to the load indicated by the information by performing a predetermined calculation using the load.

5. The device of claim 2, further comprising an image generating unit configured to generate image data displaying the allowable operation range determined by the range setting unit.

6. The device of claim 1, further comprising an alarm generating unit configured to generate an alarm when the operation limiting unit prohibits the operation of the robot moving away from the allowable operation range.

7. A device configured to set an operation parameter of a robot configured to perform a predetermined operation, the device comprising:
an information acquisition unit configured to acquire information on a load applied to the robot;
a parameter setting unit configured to set the operation parameter to cause the robot to execute the predetermined operation, based on the information acquired by the information acquisition unit; and
a range determination unit configured to determine whether or not the robot is outside of an allowable operation range which is determined in response to the load indicated by the information acquired by the information acquisition unit,
wherein the parameter setting unit is configured to suspend the setting of the operation parameter when the range determination unit determines that the robot is outside of the allowable operation range.

8. The device of claim 7, wherein the operation parameter includes at least one of the load and the allowable operation range.

9. The device of claim 8, wherein the parameter setting unit is configured to set the allowable operation range as the operation parameter when the range determination unit determines that the robot is inside of the allowable operation range, and
wherein the device further comprises an operation limiting unit configured to permit the operation of the robot moving within the allowable operation range while prohibiting the operation of the robot moving to outside of the allowable operation range.

10. The device of claim 7, further comprising an alarm generating unit configured to generate an alarm when the range determination unit determines that the robot is outside of the allowable operation range.

11. The device of claim 1, wherein the allowable operation range includes at least one of:
an allowable position range defining an allowable range of a position of the robot; and
an allowable orientation range defining an allowable range of an orientation of the robot.

12. The device of claim 11, wherein the allowable orientation range is determined as an angle of a wrist axis of the robot from a vertical direction.

13. The device of claim 1, further comprising an alarm generating unit configured to generate an alarm when the robot executing the operation within the allowable operation range approaches a boundary of the allowable operation range.

14. The device of claim 1, further comprising a contact determination unit configured to determine whether or not the robot comes into contact with an environmental object, based on detection data of a force sensor configured to detect an external force applied to the robot,
wherein the operation limiting unit is configured to permit a retraction operation of the robot moving toward outside of the allowable operation range to eliminate the contact, when the contact determination unit determines that the robot comes into contact with the environmental object.

15. A method of limiting an operation of a robot, the method comprising:
acquiring, by a processor, information on a load applied to the robot; determining, by the processor, whether or not the robot is outside of an allowable operation range which is determined in response to the load, based on the acquired information; and
permitting, by the processor, the operation of the robot moving toward inside of the allowable operation range while prohibiting the operation of the robot moving away from the allowable operation range, when determining that the robot is outside of the allowable operation range.

16. A method of setting an operation parameter of a robot configured to perform a predetermined operation, the method comprising:
acquiring, by a processor, information on a load applied to the robot;
setting, by the processor, the operation parameter to cause the robot to execute the predetermined operation, based on the acquired information;
determining, by the processor, whether or not the robot is outside of an allowable operation range which is determined in response to the load indicated by the acquired information; and
suspending, by the processor, the setting of the operation parameter when determining that the robot is outside of the allowable operation range.

17. A computer-readable non-transitory recording medium configured to record a computer program that causes the processor to execute the method of claim 15.
